(19) United States
(12) Patent Application Publication
(10) Pub. No.: US 2021/0136032 A1
(43) Pub. Date: May 6, 2021

(54) METHOD AND APPARATUS FOR GENERATING SUMMARY OF URL FOR URL CLUSTERING

(71) Applicant: SAMSUNG SDS CO., LTD., Seoul (KR)

(72) Inventors: Jang Ho KIM, Seoul (KR); Young Min CHO, Seoul (KR); Jung Bae JUN, Seoul (KR); Jang Mi SHIN, Seoul (KR); Tae Jin IYN, Seoul (KR)

(21) Appl. No.: 17/081,095

(22) Filed: Oct. 27, 2020

(30) Foreign Application Priority Data
Nov. 6, 2019 (KR) 10-2019-0140901

(51) Int. Cl. H04L 29/12; H04L 29/06

(52) U.S. Cl. CPC H04L 61/303; H04L 61/6004; H04L 63/1416

(57) ABSTRACT

A method for generating a summary of URL (Uniform Resource Locator) according to an aspect of the inventive concept is performed by a computer device. The method may include obtaining a URL, parsing the URL to extract fields from the URL, generating attribute information indicating characteristics of each field for the fields, and generating a summary of the URL using the attribute information. A summary of an URL may be generated by reflecting structural characteristics of the URL, and the summary may be provided to URL clustering. Therefore, URL clustering in which the structural characteristics of the URL are fully reflected becomes possible. Furthermore, unlike existing machine learning-based clustering, a URL summary is generated based on rules and applied to URL clustering. Therefore, an operation time required for URL summarization or clustering is short, and it is possible to immediately reflect new data.

This application claims the benefit of Korean Patent Application No. 10-2019-0140901 filed on Nov. 6, 2019, in the Korean Intellectual Property Office, the disclosure of which is incorporated herein by reference in its entirety.

### BACKGROUND

### 1. Field

The present inventive concept relates to a method and apparatus for generating a summary of an URL. More specifically, it relates to a method and apparatus for generating a summary of an URL for URL clustering.

### 2. Description of the Related Art

As the threat of cyber attack or hacking increases in recent years, many organizations and companies are making great efforts to detect cyber attacks or hacking attempts in advance by analyzing URL (Uniform Resource Locator) logs accessed from the outside through networks. This is done in a manner such that normal logs and malicious logs are classified among the collected URL logs, and when a malicious log is detected, a warning is issued or a corresponding action is taken.

In order to effectively detect malicious logs in URL logs that are collected in a large amount of billions or more per day, a technology that may automatically cluster similar URLs is essential. Various methods have been tried in the related art for URL clustering. For example, the following methods were commonly used: clustering URLs having similar texts through natural language processing algorithms, clustering similar URLs using an algorithm for calculating a distance between strings such as the Euclidean distance calculation formula, or clustering similar URLs using machine learning algorithms such as K-means clustering.

However, these conventional methods divide characters included in a URL into word units or process and analyze texts based on a morpheme of a natural language. Therefore, structural characteristics of the URL were not properly reflected in the process of preprocessing the text. Moreover, they were somewhat unsuitable for the security log field where it is necessary to analyze URL logs in character units.

In addition, the conventional methods mainly determined a degree of similarity based on a vector distance of texts included in the URL. In this regard, in general, URLs are characterized by the type, shape, or length of the text rather than the vector distance (or semantic similarity) of the text. Therefore, it was difficult to properly cluster URLs in the conventional way.

In particular, among the conventional clustering methods, machine learning-based methods have a problem that a lot of time is required for deep learning training. Moreover, when a new URL is collected, it was necessary to relearn the entire URL including the existing URL to reflect it. Therefore, there was a problem that it was not suitable for the security log field requiring real-time clustering.

### SUMMARY

Aspects of the inventive concept provide a method and apparatus for generating a summary of a URL for URL clustering by reflecting structural characteristics of the URL.

Aspects of the inventive concept also provide a method and apparatus for analyzing a URL log in character units and generating a summary of a URL based on the type, shape, or length of a URL text.

Aspects of the inventive concept also provide a method and apparatus for generating a summary of a URL that may contribute to real-time clustering because an operation time is short and new data may be immediately reflected.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

According to aspects of the inventive concept, a method for generating a summary of URL (Uniform Resource Locator) is performed by a computer device and comprises obtaining a URL, parsing the URL to extract a plurality of fields from the URL, generating attribute information indicating characteristics of each field for the plurality of fields, and generating a summary of the URL using the attribute information.

According to aspects of the inventive concept, an apparatus for generating a summary of a URL comprises a processor, a memory for loading a computer program executed by the processor, and a storage for storing the computer program, wherein the computer program comprises instructions for performing operations to obtain a URL, parse the URL to extract a plurality of fields from the URL, generate attribute information indicating characteristics of each field for the plurality of fields, and generate a summary of the URL using the attribute information.

According to aspects of the inventive concept, a computer program is stored on a computer-readable recording medium, the computer program is combined with a computing device to execute a method for generating a summary of a URL, and the computer program executes the method to obtain a URL, parse the URL to extract a plurality of fields from the URL, generate attribute information indicating characteristics of each field for the plurality of fields, and generate a summary of the URL using the attribute information.

According to various embodiments of the inventive concept described above, a summary of a URL for URL clustering may be generated by reflecting structural characteristics of the URL.

In addition, a URL log may be analyzed in character units, and a summary of a URL may be generated based on the type, shape, or length of a URL text and provided for URL clustering.

Also, since an operation time required to generate a URL summary is short and new data may be immediately reflected, it is possible to contribute to real-time URL clustering.

The benefits of the inventive concept are not limited to the benefits mentioned above, and other benefits not mentioned may be clearly understood by those skilled in the art from embodiments of the inventive concept.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram illustrating an apparatus for generating a URL summary according to some embodiments of the present disclosure;

FIG. 2 is a flowchart illustrating a method for generating a URL summary according to some embodiments of the present disclosure;

FIG. 3 is a block diagram illustrating an embodiment in which a configuration of a preprocessing unit 110 shown in FIG. 1 is embodied;

FIG. 4 is a diagram conceptually illustrating a method for extracting a field from a URL by the preprocessing unit 110 of FIG. 3;

FIG. 5 is a flowchart illustrating an embodiment in which a step of generating attribute information of FIG. 2 (S130) is embodied;

FIG. 6 is a flow chart illustrating an embodiment in which a configuration of a URL summary generation unit 120 shown in FIG. 1 is embodied;

FIG. 7 is a diagram illustrating a specific example of generating attribute information from each of fields 52, 53, 54, and 55 by the method described in FIGS. 5 and 6;

FIG. 8 is a diagram illustrating a result of generating a summary of a URL using attribute information of each field of an URL according to some embodiments of the present disclosure;

FIG. 9 is a flow chart showing an embodiment in which a step of clustering a URL of FIG. 2 (S150) is embodied;

FIG. 10 is a block diagram illustrating a specific configuration of a clustering unit 130 shown in FIG. 1 and a result of clustering URLs;

FIG. 11 is a flowchart illustrating a method for generating a URL summary according to some other embodiments of the present disclosure;

FIG. 12 is a diagram conceptually illustrating a method for detecting whether external abnormal access or cyber attack occurs according to the method illustrated in FIG. 11; and

FIG. 13 is a diagram illustrating an exemplary computing device capable of implementing devices according to various embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present invention, when it is determined that the detailed description of the related well-known configuration or function may obscure the gist of the present invention, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the invention. In this specification, the singular also includes the plural unless specifically stated otherwise in the phrase.

In addition, in describing the component of this invention, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, some embodiments of the present invention will be described in detail with reference to the accompanying drawings.

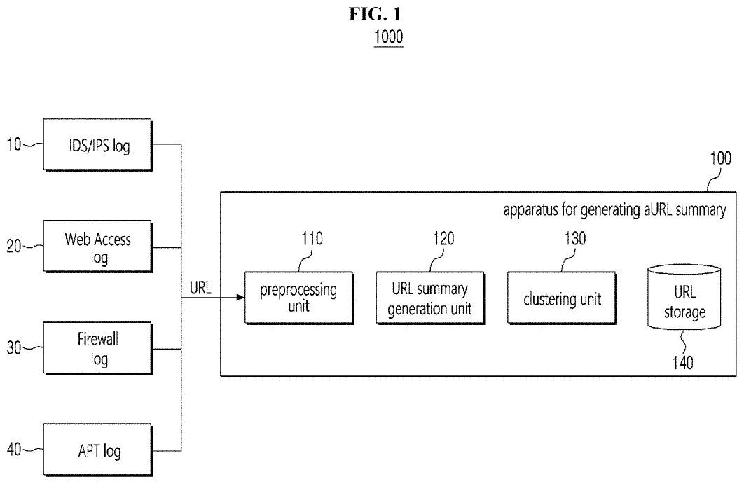

FIG. 1 is a block diagram illustrating an apparatus for generating a URL summary according to some embodiments of the present disclosure. Referring to FIG. 1, a system environment 1000 in which an apparatus 100 for generating a URL summary operates is illustrated. In the system environment 1000, the apparatus 100 for generating the URL summary receives a URL from the outside and processes it to generate a summary of the URL. As an example, the URL summary generation apparatus 100 may include a preprocessing unit 110, a URL summary generation unit 120, a clustering unit 130, and a URL storage 140.

The preprocessing unit 110 collects a URL from the outside, parses the URL, and preprocesses it in a form suitable for generating a URL summary. To this end, the preprocessing unit 110 first collect a URL through various external paths, for example, an IDS/IPS log 10, a web access log 20, a firewall log 30, or an APT log 40. Then, by parsing the URL, a plurality of predefined fields (e.g., a domain field, a path field, a file and extension field, or a parameter field) are extracted from text constituting the URL. The fields extracted by the preprocessing unit 110 are provided to the URL summary generation unit 120.

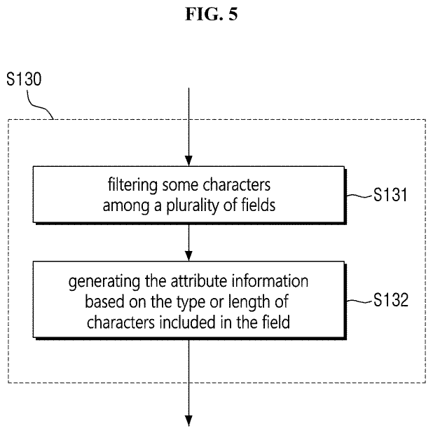

The URL summary generation unit 120 generates attribute information indicating characteristics of each field for the plurality of fields provided by the preprocessing unit 110. Here, the URL summary generation unit 120 generates the attribute information so as to abbreviate the type, form, or length of the text included in each field without giving much weight to a linguistic meaning indicated by the text included in each field. A detailed method for generating attribute information for each field by the URL summary generation unit 120 will be described later in detail with reference to FIGS. 5 to 8, and thus a detailed description thereof will be omitted.

The URL summary generation unit 120 generates a summary of the URL based on the generated attribute information. Here, the URL summary generation unit 120 may generate the summary of the URL by combining the generated attribute information of each of the fields. The URL summary generation unit 120 provides the generated URL summary to the clustering unit 130.

The clustering unit 130 clusters the URL based on the provided summary of the URL. Here, the clustering unit 130 clusters URLs such that URLs having the same summary belong to the same cluster. As an embodiment, if the URL summary is provided from the URL summary generation unit 120, the clustering unit 130 compares whether the provided URL summary is the same as a summary of the existing URL, and clusters the provided URL into a cluster of the existing URL when the provided URL is the same. On the other hand, when the URL summary provided is different from that of the existing URL, the clustering unit 130 clusters the provided URL summary into a new cluster different from the cluster of the existing URL. The URL for which the clustering unit 130 has completed clustering and clustering information of the URL may be stored in the URL storage 140.

According to the configurations of the embodiment described above, a summary of an URL is generated by reflecting structural characteristics of the URL, and the summary is provided to URL clustering. Therefore, URL clustering in which the structural characteristics of the URL are fully reflected becomes possible.

In addition, when generating the URL summary, the type, shape, or length of a URL text is analyzed in character units. Therefore, it may overcome the problems of the existing clustering method, which was not suitable for the security log field.

Furthermore, unlike existing machine learning-based clustering, a URL summary is generated based on rules and applied to URL clustering. Therefore, an operation time required for URL summarization or clustering is short, and it is possible to immediately reflect new data.

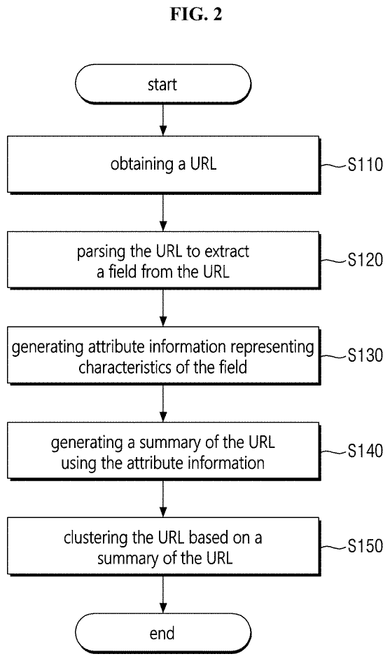

In FIG. 2 and the following drawings, specific embodiments of a method for summarizing an URL performed by the apparatus 100 for generating the URL summary shown in FIG. 1 will be described. Therefore, when a subject performing each step of a method for generating a URL summary is not specified in FIG. 2 and the following drawings, it is assumed that the performing subject is the apparatus 100 for generating the URL summary described above.

FIG. 2 is a flowchart illustrating a method for generating a URL summary according to some embodiments of the present disclosure. Referring to FIG. 2, the method for generating the URL summary includes five steps of steps S110 to S150.

In step S110, the apparatus 100 for generating the URL summary obtains a URL through various paths. For example, the apparatus 100 for generating the URL summary may obtain a plurality of URLs from an IDS/IPS log 10, a web access log 20, a firewall log 30, or an APT log 40.

In step S120, the apparatus 100 for generating the URL summary parses the obtained URL to extract a plurality of predefined fields from text constituting the URL. Here, the plurality of fields to be extracted may include a domain field, a path field, a file and extension field, or a parameter field.

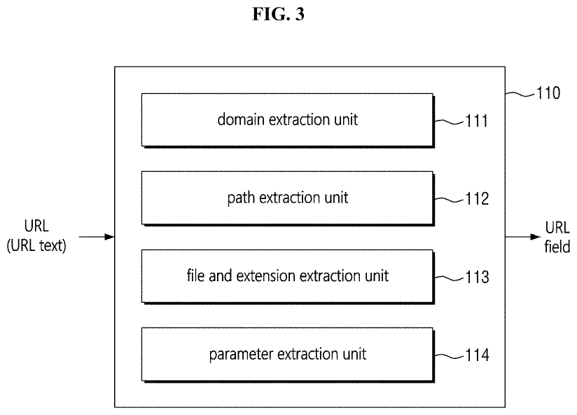

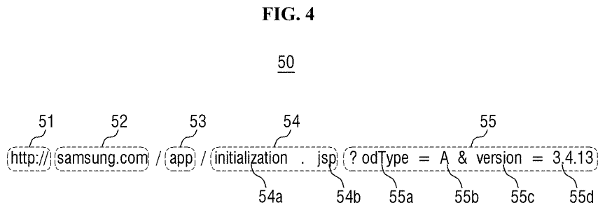

For a more detailed description of this, the related description will be continued with reference to FIGS. 3 and 4. FIG. 3 is a block diagram illustrating an embodiment in which a configuration of the preprocessing unit 110 shown in FIG. 1 is embodied. FIG. 4 is a diagram conceptually illustrating a method for extracting a field from a URL by the preprocessing unit 110 of FIG. 3.

First, referring to FIG. 3, the preprocessing unit 110 includes a domain extraction unit 111 for extracting a domain field from an input URL (or URL text), a path extraction unit 112 for extracting a path field, a file and extension extraction unit 113 for extracting a file and extension field, and a parameter extraction unit 114 for extracting a parameter field. Generally, since a URL is generated according to a predetermined rule by a computer program, elements constituting the URL do not significantly deviate from a predetermined format and range.

For example, as shown in FIG. 4, generally, a URL 50 includes a preamble field 51 containing a phrase “http://” at the beginning, a domain field 52 representing a domain address, a path field 53 representing a path of a file executed through the URL, a file and extension field 54 indicating a name 54a and extension 54b of the file to be executed, and a parameter field 55 representing a query string consisting of multiple keys 55a, 55c and values 55b, 55d. In addition, an order in which the fields are arranged in the URL is also formal, and the fields are usually arranged in the order shown in FIG. 4.

With reference to this point, the preprocessing unit 110 parses the URL 50 and analyzes which fields correspond to text portions 51, 52, 53, 54, and 55 of the URL 50. Then, based on a result of analysis, fields to be extracted are extracted from the URL 50 according to a predetermined criterion. For example, in the case of the preamble field 51, since it does not contribute to characterizing the URL, it is not necessary to extract it and is not included in an extraction target. On the other hand, the domain field 52, the path field 53, the file and extension field 54, and the parameter field 55 are included in the extraction target because the corresponding URL 50 may be characterized accordingly. In this way, the preprocessing unit 110 extracts predetermined fields 52, 53, 54, and 55 from an original text of the URL 50.

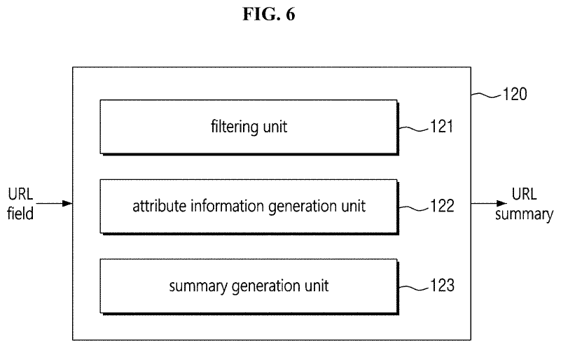

In step S130, the apparatus 100 for generating the URL summary generates attribute information representing characteristics of each field for the extracted fields 52, 53, 54, and 55. FIGS. 5 to 6 will be referred to for a more detailed description of step S130. FIG. 5 is a flowchart illustrating an embodiment in which a step of generating attribute information of FIG. 2 (S130) is embodied. FIG. 6 is a flow chart illustrating an embodiment in which a configuration of the URL summary generation unit 120 performing the steps of FIG. 5 is embodied.

First, referring to FIG. 5, in step S131, the URL summary generation unit 120 filters some unnecessary characters that are not used for URL classification among the fields 52, 53, 54, and 55 provided by the preprocessing unit 110. For example, for a URL, alphabetical characters, numeric characters, or special characters are significant components of URL classification. However, characters in Korean, Chinese, or Japanese are generally not used in URL attack phrases, so they have little meaning for the URL classification. Therefore, in order to facilitate subsequent steps, in step S131, some characters that are not used for the URL classification are filtered out of the extracted fields 52, 53, 54, 55. This filtering process may be performed by a filtering unit 121 of FIG. 6.

Then, in step S132, the URL summary generation unit 120 generates attribute information indicating characteristics of each field based on the type or length of characters included in the extracted fields 52, 53, 54, and 55. Here, the URL summary generation unit 120 may generate the attribute information so as to abbreviate the type, form, or length of the text included in each field without giving much weight to a linguistic meaning indicated by the text included in each field. However, exceptionally, since the domain field 52 itself represents a unique characteristic, it is assumed that text included in the domain field 52 is maintained as it is when generating attribute information.

When generating attribute information for the remaining fields 53, 54, and 55, the attribute information may be generated by applying a different rule to each of the fields 53, 54, and 55 so as to reflect unique characteristics of each of the fields 53, 54, and 55.

As an embodiment, when generating attribute information for the path field 53, the URL summary generation unit 120 may refer to one or more characters consecutively positioned in the path field 53, and construct the attribute information with an identification character representing the type and a number representing a length. Here, the identification character may be a character indicating whether the type of characters included in the path field 53 is an alphabetic character, a numeric character, or a special character. For example, if the type of characters is an alphabetical character, the identification character is “A” referring to an acronym of an alphabet, if the type of characters is a number, the identification character becomes “N” referring to an acronym of a number, and if the type of characters is a special character, the identification character is “S” referring to an acronym of a special character.

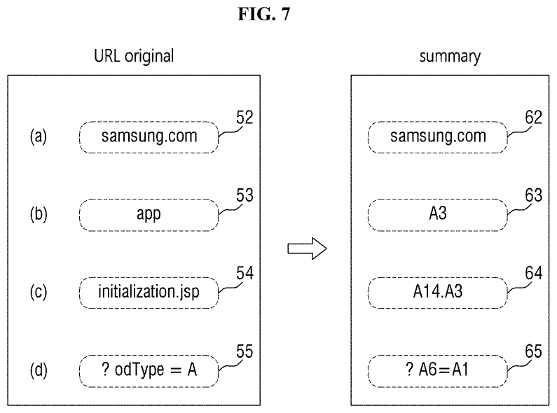

For example, referring to FIG. 7, the text “app” is included in the path field 53. Since the type of these characters is an alphabetical character, the identification character is “A”, and a length (number) of the characters is “3.” In this case, attribute information 63 of the path field 53 is determined as “A3” in which “A” and “3” are combined.

As an embodiment, when generating attribute information for the file and extension field 54, the URL summary generation unit 120 may configure the attribute information such that a file name of the file and extension field 53 is represented by an identification character indicating the type of characters constituting the file name and a number indicating a length of the characters, and an original text is maintained as an extension itself has a certain characteristic meaning.

For example, referring to FIG. 7, the text “initialization.jsp” is included in the file and extension field 54. Among them, “initialization” corresponds to the file name 54a. Therefore, it is represented as “A14” combined with the identification character “A” representing the type of the characters and the number “14” representing the length of the characters. On the other hand, since “jsp” corresponds to the extension 54b, “jsp” is maintained as it is. Accordingly, the attribute information 64 of the file and extension field 54 is determined as “A14.jsp” in which “A14” and “jsp” are combined. Meanwhile, it is assumed that a period (.) positioned between “A14” and “jsp” is maintained as it is, like the extension 54b.

As an embodiment, when generating attribute information for the parameter field 55, the URL summary generation unit 120 may include, in the attribute information, only identification characters indicating the type of characters of the same type consecutive to each other in the parameter field 55, and not the length of the characters. This is because a length of a key and value included in the parameter field 55 is generally not important in the attack parsing of the URL. Meanwhile, since special characters included in the parameter field 55 may have meaning in URL classification, it is assumed that the original text is maintained.

For example, referring to FIG. 7, the parameter field 55 includes the text “? odType=A.” Among them, the alphabetical character “odType” corresponding to the key 55a is represented by the identification character “A” indicating the type, and the

Alphabetical character “A” corresponding to the value 55b appearing next is also represented by the identification character “A” indicating the type. Also, the rest of the special characters remain the same. Accordingly, in the attribute information 65 of the parameter field 55, the special character “?,” the “A14,” the special character “=,” and the “A” are combined in order of “?A=A.” A series of processes for generating attribute information described above may be performed by an attribute information generation unit 122 of FIG. 6.

Returning to FIG. 2 again, in step S140, the apparatus 100 for generating the URL summary generates a summary of the URL using the previously generated attribute information. As an embodiment, the URL summary generation unit 120 may generate the summary of the URL by combining the generated attribute information of each of the fields. Here, a separate separator character (e.g., “/”) may be positioned between each of the combined attribute information to distinguish it. For example, referring to the example of FIG. 7 above, attribute information 62, 63, 64, 65 of each field 52, 53, 54, 55 of the URL are sequentially combined, and a summary of the URL like “samsung.com/A3/A14.jsp/?A=A” is generated. The summary generated in this way puts emphasis on the type, form, and length of the text rather than the linguistic meaning of the text included in the URL. For example, except for a domain part and an extension part indicating unique characteristics, the URL is configured to generate the same summary as long as the type and length of the characters are the same even when other words or characters are included.

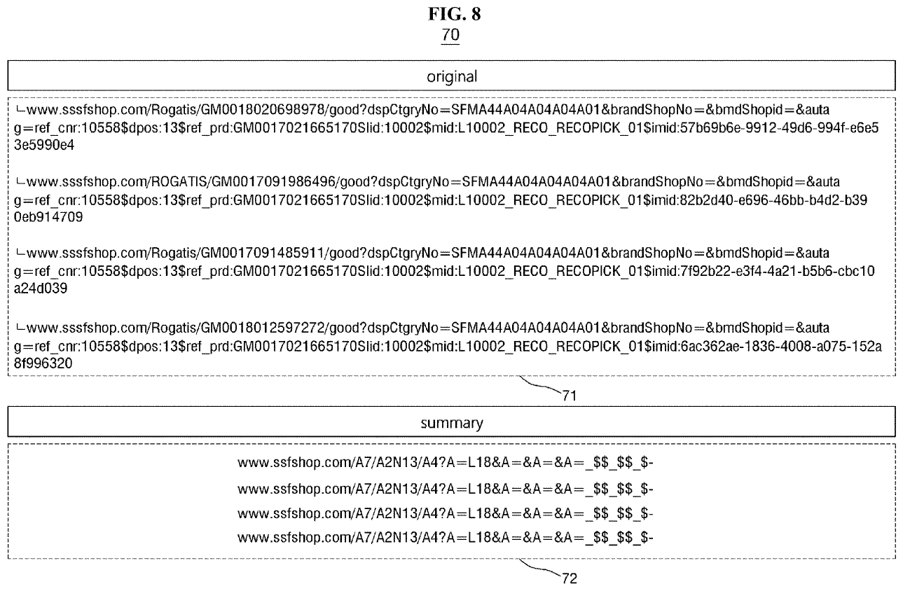

Referring to FIG. 8, some examples of generating a summary of a URL according to embodiments of the present disclosure are shown. Even when an original text 71 of a URL is different from each other, it may be seen that a URL summary 72 is generated identically.

Such a URL summary may itself function as a URL cluster. For example, if summaries of two URLs are identical, it means that the two URLs have the exact same text structure such as a domain name as well as a file path, a file name, or a query string. This is because the two URLs are likely to have a deep relationship with each other due to the nature of a URL syntax. Therefore, it is possible to manage URLs having the same URL summary in the same cluster.

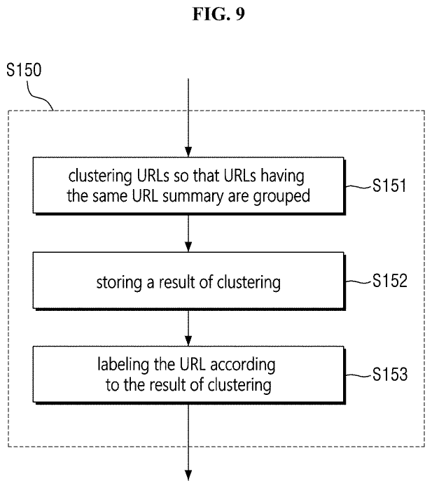

Hereinafter, a method for managing a cluster of URLs based on a URL summary will be described. FIG. 9 is a flow chart showing an embodiment in which the step of clustering a URL of FIG. 2 (S150) is embodied. Referring to FIG. 9, step S150 consists of three steps of steps S151 to S153.

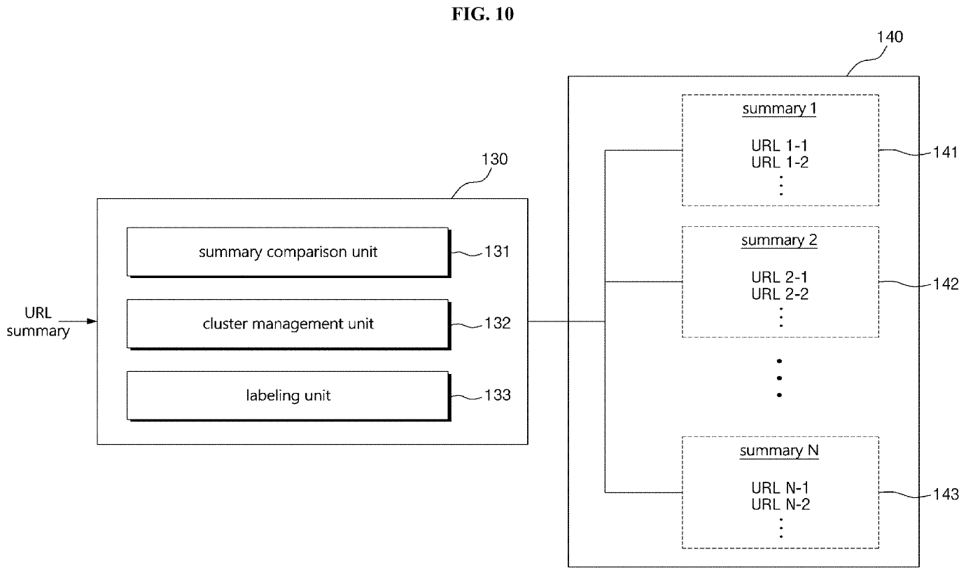

In step S151, the apparatus 100 for generating the URL summary clusters URLs so that URLs having the same URL summary are grouped (or clustered). As described above, since the URL summary is the same means that characteristics of URL syntax are the same, such URLs may be classified and managed in the same cluster. According to this method, if only a summary of a URL is generated, a separate operation process for clustering is not required. Therefore, the effect of automatically clustering a URL may be obtained. Accordingly, URLs may be quickly clustered in real time. In addition, even when a new URL is collected, clustering may be performed immediately by just generating its URL summary. Step S151 may be performed by a cluster management unit 132 of FIG. 10.

In step S152, the apparatus 100 for generating the URL summary may store the URL and its summary in the URL storage 140 as a result of clustering. Referring to

FIG. 10, an embodiment in which a result of clustering is stored in the URL storage 140 is shown. As shown in FIG. 10, URLs having the same summary are classified into one cluster. For example, a URL 1-1 and a URL 1-2 are clustered into one cluster 141 by “Summary 1”, which is their own URL summary. Similarly, a URL 2-1, a URL 2-2, or the like are clustered into another cluster 142 by “Summary 2,” and a URL N-1, a URL N-2, or the like are clustered into another cluster 143 by “Summary N.”

In step S153, the apparatus 100 for generating the URL summary labels the URL according to the result of clustering the URL. In some cases, separate labeling may be required for URLs clustered by a URL summary. For example, when it is determined that URLs with a specific summary are related to malicious logs (or when a summary of URLs determined to be related to malicious logs is identified), one may manage potential cyber attacks or threats by labeling the “malicious log” URLs with that summary. In this case, since URLs are clustered and labeled based on a URL summary, the same labeling is made for all URLs having the same URL summary. Step S153 may be performed by a labeling unit 133 of FIG. 10.

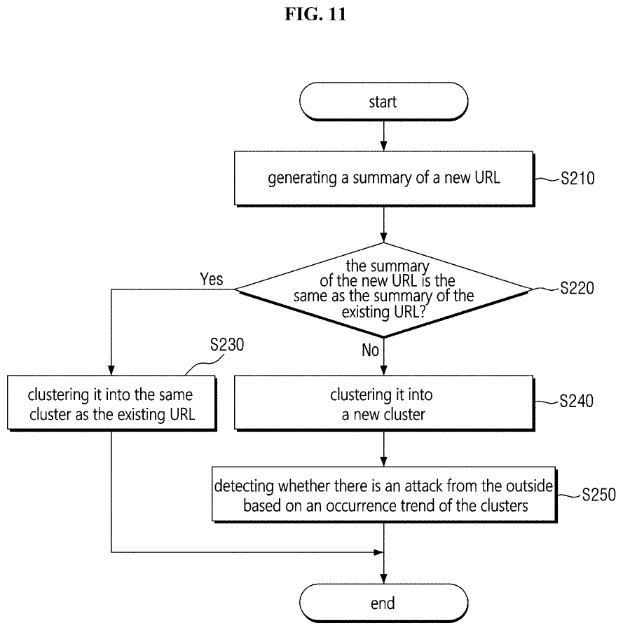

FIG. 11 is a flowchart illustrating a method for generating a URL summary according to some other embodiments of the present disclosure. In the embodiment of FIG. 11, a method for clustering when a new URL is collected after clustering of existing URLs is completed by a URL summary is described. Referring to FIG. 11, the present embodiment includes five steps of steps S210 to S250.

In step S210, the apparatus 100 for generating the URL summary generates a summary of a new URL. Since a method for generating a new URL summary is the same as the method for generating the URL summary described in FIGS. 1 to 10 above, further detailed descriptions will be omitted to avoid duplication of description.

In step S220, the apparatus 100 for generating the URL summary determines whether the summary of the new URL is identical to each other by comparing the summary of the existing URL. If they are the same, the present embodiment proceeds to step S230. Otherwise, the present embodiment proceeds to step S240.

In step S230, the apparatus 100 for generating the URL summary clusters the new URL into the same cluster as the existing URL. In embodiments of the present disclosure, clustering is performed based on a summary of a URL. Therefore, when a summary of a new URL is the same as a summary of an existing URL, it is automatically clustered into the same cluster (i.e., a cluster grouped by one summary as shown in FIG. 10) as the existing URL.

Meanwhile, when it proceeds to step S240, the apparatus 100 for generating the URL summary clusters the new URL into a new cluster grouped by its URL summary. In this case, since there is no existing URL summary identical to the new URL, a new cluster is naturally created with the summary of the new URL.

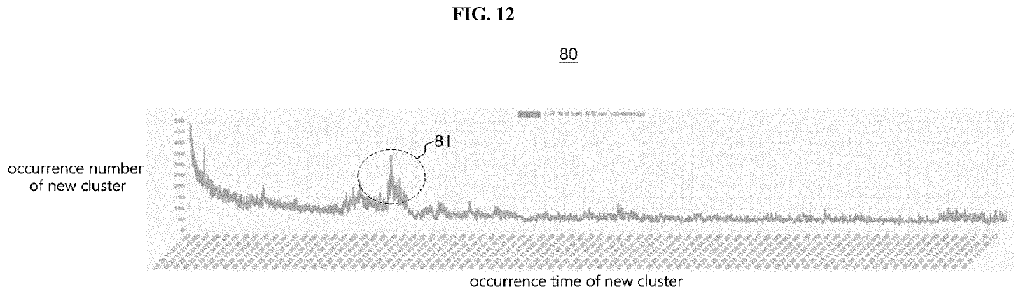

In step S250, the apparatus 100 for generating the URL summary detects whether there is abnormal access or cyber attack from the outside based on an occurrence trend of new clusters including the new cluster. For description of step S250, refer to FIG. 12. FIG. 12 is a graph showing a degree of occurrence of new clusters over time when URLs are clustered according to the present disclosure. In the graph of FIG. 12, a horizontal axis indicates an occurrence time of a new cluster, and a vertical axis indicates the number of occurrences of the new cluster.

Referring to FIG. 12, since there is no existing URL summary initially created, there is a high possibility that a URL summary generated for the collected URL will generate a new cluster. Therefore, the number of new clusters is initially high. Then, when the generation of summaries of URLs has been finished to some extent, most of the URLs collected afterwards will overlap with the existing URLs. Therefore, increasingly, new clusters are not created. Accordingly, in a general situation, the graph of FIG. 12 is drawn downward to the right. However, as shown in a dotted circle 81 of FIG. 12, the graph sometimes deviates from a downward trend and indicates a peak. This means that URLs having a syntax structure different from those previously identified are suddenly being identified in large numbers. There is a high probability that it is caused by abnormal access or cyber attack from the outside. Therefore, when the apparatus 100 for generating the URL summary monitors the occurrence trend of new clusters as described above and a portion suddenly deviating from the trend of the graph such as the dotted circle 81 is identified, one may determine this as a potential threat and issue an alert or take appropriate action.

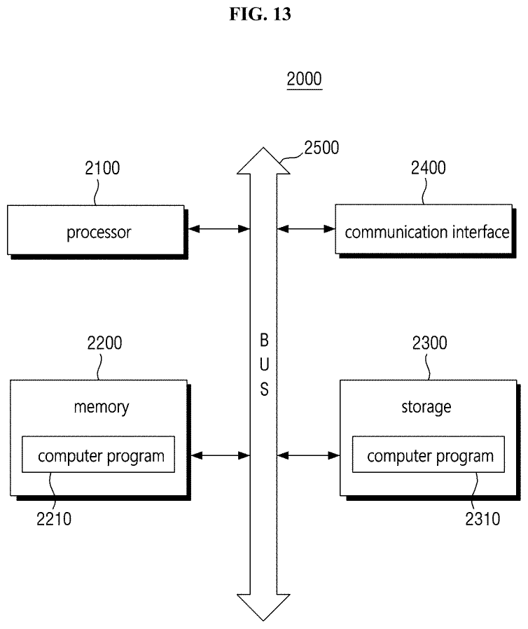

Hereinafter, an exemplary computing device 2000 that can implement an apparatus and a system, according to various embodiments of the present disclosure will be described with reference to FIG. 13.

FIG. 13 is an example hardware diagram illustrating a computing device 2000.

As shown in FIG. 13, the computing device 2000 may include one or more processors 2100, a bus 2500, a communication interface 2400, a memory 2200, which loads a computer program 2210 executed by the processors 2100, and a storage 2300 for storing the computer program 2310. However, FIG. 13 illustrates only the components related to the embodiment of the present disclosure, Therefore, it will be appreciated by those skilled in the art that the present disclosure may further include other general purpose components in addition to the components shown in FIG. 13.

The processor 2100 controls overall operations of each component of the computing device 2000. The processor 2100 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 2100 may perform calculations on at least one application or program for executing a method/operation according to various embodiments of the present disclosure. The computing device 2000 may have one or more processors.

The memory 2200 stores various data, instructions and/or information. The memory 2200 may load one or more programs 2210 from the storage 2300 to execute methods/operations according to various embodiments of the present disclosure. An example of the memory 2200 may be a RAM, but is not limited thereto.

The bus 2500 provides communication between components of the computing device 2000. The bus 2500 may be implemented as various types of bus such as an address bus, a data bus and a control bus.

The communication interface 2400 supports wired and wireless internet communication of the computing device 2000. The communication interface 2400 may support various communication methods other than internet communication. To this end, the communication interface 2400 may be configured to comprise a communication module well known in the art of the present disclosure.

The storage 2300 can non-temporarily store one or more computer programs 2310. The storage 2300 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 2210 may include one or more instructions, on which the methods/operations according to various embodiments of the present disclosure are implemented.

An example, the computer program 2210 may comprise instructions for performing operations to obtain a URL, parse the URL to extract a plurality of fields from the URL, generate attribute information indicating characteristics of each field for the plurality of fields, generate a summary of the URL using the attribute information, and clustering the URL based on the summary of the URL.

Another example, the computer program 2210 may comprise instructions for performing operations to generate a summary of a new URL, compare the summary of the new URL with a summary of an existing URL, cluster the new URL into the same cluster as the existing URL when the summary of the new URL is the same as the summary of the existing URL, cluster the new URL into a new cluster when the summary of the new URL is different from the summary of the existing URL, and detect abnormal access or cyber attack from the outside based on a trend of occurrence of clusters including the new cluster.

When the computer program 2210 is loaded on the memory 221)0, the processor 2100 may perform the methods/operations in accordance with various embodiments of the present disclosure by executing the one or more instructions.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although the operations are shown in a specific order in the drawings, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation. The scope of protection of the present invention should be interpreted by the following claims, and all technical ideas within the scope equivalent thereto should be construed as being included in the scope of the technical idea defined by the present disclosure.

What is claimed is:

1. A method for generating a summary of URL (Uniform Resource Locator) performed by a computer device, comprising:
obtaining a URL;
parsing the URL to extract a plurality of fields from the URL;
generating attribute information indicating characteristics of each field for the plurality of fields; and
generating a summary of the URL using the attribute information.

2. The method of claim 1, wherein the plurality of fields comprise a path field, a file and extension field, or a parameter field.

3. The method of claim 2, wherein generating the attribute information indicating the characteristics of each field comprises generating the attribute information including an identification character indicating the type of one or more characters which are included in the path field and consecutively positioned with each other and a number indicating a length of the one or more characters.

4. The method of claim 2, wherein generating the attribute information indicating the characteristics of each field comprises generating the attribute information including an identification character indicating the type of one or more characters which are included in a file name of the file and extension field and consecutively positioned with each other and a number indicating a length of the one or more characters.

5. The method of claim 4, wherein the attribute information further comprises one or more other characters included in an extension of the file and extension field.

6. The method of claim 4, wherein the type of the one or more characters is an alphabetic character, a numeric character, or a special character.

7. The method of claim 2, wherein generating the attribute information indicating the characteristics of each field comprises generating the attribute information including a first identification character indicating the type of one or more characters which are included in the parameter field and consecutively positioned with each other and a second identification character indicating the type of one or more other characters which are included in the parameter field and consecutively positioned with each other.

8. The method of claim 7, wherein the attribute information further comprises a special character included in the parameter field.

9. The method of claim 7, wherein the one or more characters are characters indicating a key of the parameter field; and
the one or more other characters are characters indicating a value of the parameter field.

10. The method of claim 1, wherein generating the attribute information indicating the characteristics of each field comprises filtering some of characters included in the plurality of fields.

11. The method of claim 1, further comprising:
clustering the URL based on the summary of the URL.

12. The method of claim 11, further comprising:
labeling the URL according to a result of the clustering.

13. The method of claim 11, further comprising:
comparing the summary of the URL with a summary of another URL, and when the summary of the another URL is the same as the summary of the URL, clustering the another URL into the same cluster as the URL.

14. The method of claim 11, further comprising:
comparing the summary of the URL and a summary of another URL, and when the summary of the another URL is different from the summary of the URL, clustering the another URL into a new cluster.

15. The method of claim 14, wherein based on a trend of occurrence of clusters including the new cluster, abnormal access or cyber attack from the outside is detected.

16. An apparatus for generating a summary of a URL, the apparatus comprising:
a processor;
a memory for loading a computer program executed by the processor; and
a storage for storing the computer program,
wherein the computer program comprises instructions for performing operations to:
obtain a URL;
parse the URL to extract a plurality of fields from the URL;
generate attribute information indicating characteristics of each field for the plurality of fields; and
generate a summary of the URL using the attribute information.

17. A computer program stored on a computer-readable recording medium, the computer program being combined with a computing device to execute a method for generating a summary of a URL and executing the method to:
obtain a URL;
parse the URL to extract a plurality of fields from the URL;
generate attribute information indicating characteristics of each field for the plurality of fields; and
generate a summary of the URL using the attribute information.
